(19) United States
(12) Patent Application Publication
(10) Pub. No.: US 2019/0329947 A1
(43) Pub. Date: Oct. 31, 2019

(54) Coupling Cutting Slates

(71) Applicant: Laura J. Sparks, Lantana, TX (US)

(72) Inventor: Laura J. Sparks, Lantana, TX (US)

(21) Appl. No.: 16/394,007

(22) Filed: Apr. 25, 2019

Related U.S. Application Data
(60) Provisional application No. 62/662,583, filed on Apr. 25, 2018.

(51) Int. Cl. B65D 51/24; G01B 3/04; B65D 81/38; B65D 43/16; A47J 47/00

(52) U.S. Cl. CPC B65D 51/24; G01B 3/04; A47J 47/005; B65D 43/16; B65D 81/38

(57) ABSTRACT

A system and method for coupling a cutting slate atop a cooler lid. The cutting slate can be used to allow a user to cut, slice, and prepare food on the cutting slate without damaging the top of the cooler. The cutting slate can be coupled or secured to the cooler.

### PRIORITY

The present invention claims benefit of U.S. Provisional Patent Application No. 62/662,583 filed Apr. 25, 2018, the entirety of which is incorporated herein.

### BACKGROUND OF THE INVENTION

### Technical Field

The present invention relates to a system and method for coupling a cutting slate.

### Description of Related Art

Coolers are used outdoors to store items. One use is to keep items cool or cold. Some outdoor enthusiasts take coolers with them when they hunting or fishing so they can keep the meat cold. However, there are other uses for a cooler which are going unfulfilled. Thus, there is a need for an improved cooler system.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a perspective view of a cooler in one embodiment;

FIG. 2 is a bottom perspective view of a slate in one embodiment;

FIG. 3 is a top perspective view of a slate in one embodiment;

FIG. 4 is a top view of the coupling device in one embodiment;

FIG. 5 is a perspective view of a slate in one embodiment;

FIG. 6 is a perspective view of a slate in one embodiment;

FIG. 7 is a perspective view of a slate in one embodiment;

FIG. 8 is a perspective view of a slate in one embodiment;

FIG. 9 is a perspective view of a slate in one embodiment.

### DETAILED DESCRIPTION

Several embodiments of Applicant's invention will now be described with reference to the drawings. Unless otherwise noted, like elements will be identified by identical numbers throughout all figures. The invention illustratively disclosed herein suitably may be practiced in the absence of any element which is not specifically disclosed herein.

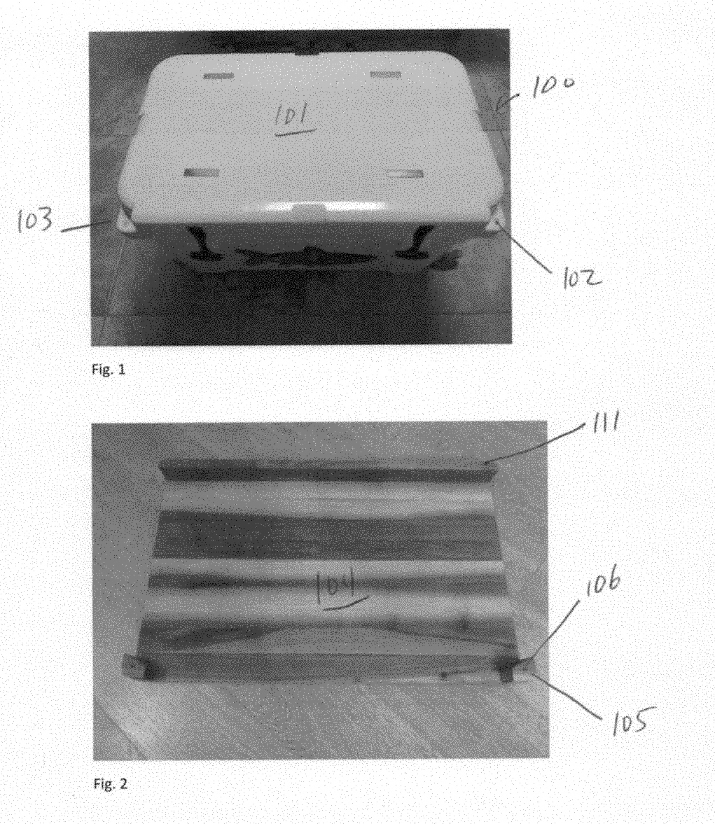

FIG. 1 is a perspective view of a cooler in one embodiment. The cooler can comprise virtually any shape and any brand of cooler. As shown in FIG. 1, a Grizzly brand cooler is used, based in Iowa, but this is for illustrative purposes only and should not be deemed limiting. In one embodiment the cutting slate can be utilized with any cooler which comprises a top which comprises at least a partially planar shape. As discussed below, the planar shape of the cooler top will be used to support a cutting slate.

As shown in FIG. 1, the cooler 100 comprises a generally planar top 101. As depicted the cooler top 101 functions as the lid of the cooler 100. Thus, to retrieve contents from the cooler, the top 101 is opened. In the embodiment depicted, the cooler top 101 is fixed via hinges (not shown) located at the rear face of the cooler 100.

As depicted the cooler top 101 comprises one or more cooler holes 102. The cooler holes 102 can be located anywhere on the top 101. The cooler holes 102, in one embodiment, are used to secure a cutting slate to the cooler. In one embodiment the holes 102 are threaded to accept a screw, bolt, etc. A slate, as used herein refers to an item which can be coupled to a cooler to provide a flat surface upon which to cut, slice, and prepare items and food. In one embodiment, as described below, the slate protects the cooler top 101. As described in more detail below, the slate can be comprised of a board of wood, a sheet of metal, a sheet of plastic, etc.

In the embodiment depicted the cooler top 101 comprises two tapered corners 103. As depicted the two tapered corners 103 are located at the front face of the cooler. As can be seen, the holes 102 are in a plane which is approximately parallel with the remainder of the cooler top 101, however, the plane with the holes 102, due to the taper, is at a lower elevation. Thus, the cooler top 101 has a planar surface, then there is a taper, and then there is a planar surface at a lower elevation.

FIG. 2 is a bottom perspective view of a slate in one embodiment. A slate, as used herein, refers to a planar surface which is used as a cutting slate. The slate 104 can comprise a variety of materials including a wooden cutting slate, plastic, metal, rubber, and combinations thereof. A cutting slate 104 is useful in that it allows items to be cut on a smooth flat surface whereby only the cutting slate 104 is cut by the blade. If a user were to filet a fish directly upon a cooler, for example, the knife would cut and damage the cooler. A cutting slate is built to withstand the damage from the knife.

The cutting slate 104 can comprise virtually any shape and any dimensions. In one embodiment the slate 104 is designed to mate with the cooler top 101. In this manner, the cutting slate 104 can be placed atop the cooler 100 where it can be used in place atop the cooler or removed and used at a different location.

As shown, the bottom side of the cutting slate 104 comprises legs 105. Legs, as used herein, refer to segments which extend upwardly beyond the planar face of the bottom face of the cutting slate. The legs 105 are designed to abut against and fit alongside the tapered corners 103 of the cooler top 101. The legs 105 allow the cutting slate 104 to be flush against the cooler top 101. This ensures a snug fit which provides stability when using the cutting slate 104.

In the two corners corresponding to the legs 105 are two cutting slate holes 106. When the cutting slate 104 is properly aligned with the cooler, the cutting slate holes 106 will align above the cooler holes 102. Once properly aligned, a coupling device, such as a screw or bolt can be inserted through the cutting slate holes 106 and through the cooler holes 102 to couple the cutting slate 104 to the cooler 100.

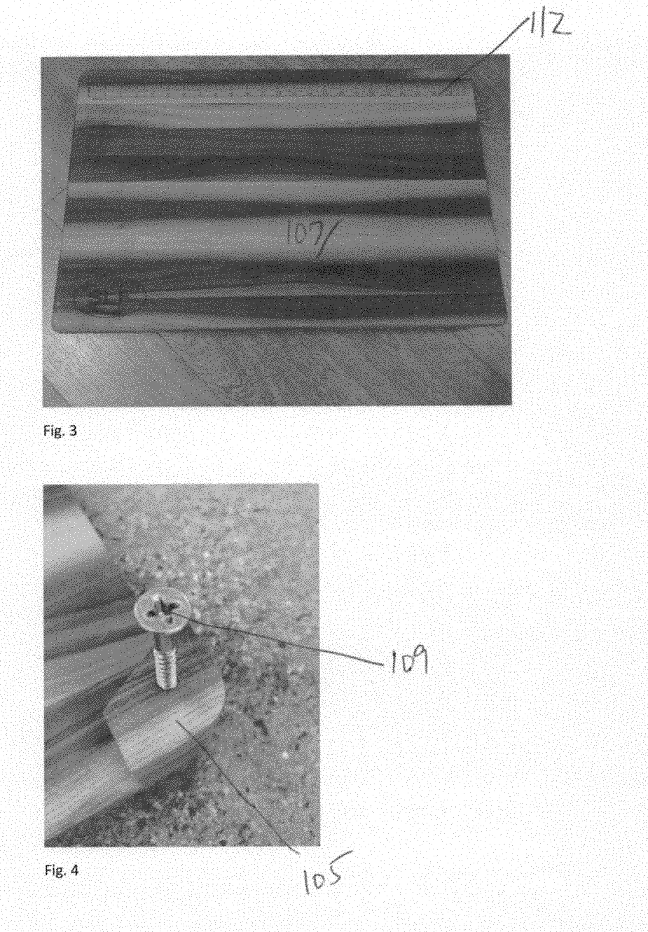

In one embodiment, and as depicted, the cutting slate holes 106 are located in the legs 105. In one embodiment, and as shown in FIGS. 2 and 3, the hole does not extend to the slate top 107. In other embodiments, however, the cutting slate holes 106 extend to the slate top 107.

Staying with FIG. 2, in one embodiment the cutting slate 104 comprises a lip 111 that raises out of the plane of the bottom side of the cutting slate 104. If the cutting slate 104 in FIG. 2 is rotated 180 degrees to align with the cooler in FIG. 1, then the feed 105 will still align with the tapered corners 103 of the cooler. The lip 111 will align with the back end of the cooler. This is an additional point of contact and increases the stability of the cutting slate when located atop the cooler 100.

FIG. 3 is a top perspective view of a slate in one embodiment. At the bottom of FIG. 3, the legs 105 are slightly visible. The cutting slate 104 comprises a cutting top 107. The cutting top 107 is the surface upon which items are placed while being cut. As noted, the cutting top 107 can comprise a variety of materials. In one embodiment the cutting top 107 comprises a food grade material. As discussed above, in this embodiment the cutting top 107 does not comprise cutting slate holes 106.

FIG. 4 is a top view of the coupling device in one embodiment. As depicted the coupling device comprises screws 109. To install the cutting slate 104 atop the cooler 101, the cutting slate 104 is placed atop the cooler 103 so that the cutting slate top 107 is facing outward away from the cooler 101. The legs 105 of the cutting slate 104 are aligned with the tapered corners 103 of the cooler 101.

After properly aligning the cutting slate 104 with the cooler 101, the screw 109 is inserted through the cooler holes 102. The screw 109 is tightened to engage with the cutting slate holes 106. In embodiments wherein the cooler holes 102 comprise threading, the screw 109 is screwed into the cooler holes 102. A tool such as an Allen wrench 110, as depicted, can be used to tighten the screws 109. In this embodiment, the screw 109 will terminate within the legs 105 and will not extend beyond the slate top 107. Those with skill in the art will understand the various other methods and devices to couple the slate to the cooler.

Once both sides are attached, the cutting slate 104 is now properly coupled to the cooler 101. The cutting slate 104 can be removed by reversing the steps. In one embodiment the cutting slate 104 can be removed for cleaning. Thus, after use, the cutting slate 104 can be removed from the cooler 100 for cleaning. In other embodiments, however, the cutting slate is cleaned while still coupled to the cooler 100.

While one embodiment has been described utilizing screws as the coupling device, this is for illustrative purposes only and should not be deemed limiting. In other embodiments the coupling device can comprise straps or other items used to secure the cutting slate to the cooler. Any coupling device can be utilized. These include both permanent and temporary coupling devices. A permanent coupling device is one which has to be removed to decouple the coupled items. A screw is an example of a permanent coupling device. However, a locking hinge, such as the hinges depicted in FIG. 1, can also be used to couple the cutting slate to the cooler. In such embodiments the hinge can be opened to decouple the cutting slate when desired.

One benefit of the embodiment discussed with the coupling mechanism is that, in some embodiments, the cutting slate 104 lifts when the cooler top 101 lifts. Thus, the cutting slate 104 acts like the top of the cooler. The user does not have to de-couple, disengage, or otherwise adjust the cutting slate 104 to open or close the cooler 100. Instead, the cutting slate 104 operates like the top of the cooler 100 with the added benefit of serving as a cutting slate when required.

As noted, coolers are often used by anglers to store the fish that have been caught. Often, these fish are filleted prior to being stored in the cooler. Previously an angler had to locate a flat surface upon which to fillet the fish. The surface needed to be one which the angler did not mind damaging as the knife often damages the underneath surface. However, by having a cutting slate 104 coupled to a cooler 100, the angler can fillet on a cutting slate 104 and then store the fish in the cooler 100. The cutting slate 104 is conveniently located atop the cooler, so the angler can fillet the fish and then throw the fish into the cooler. The angler need only open the lid of the cooler, and then deposit the fish into the cooler.

While anglers have been discussed, this is for illustrative purposes only and should not be deemed limiting. The cutting slate can also be used with hunters, for examples. A hunter may hunt any legal game. As but one non-limiting example, a hunter can take the cooler with the coupled cutting slate to a dove hunt. The hunter can retrieve the dove, cut as necessary, and then store the dove in the cooler.

While one embodiment has been discussed wherein the cutting slate 104 is coupled to the cooler 100 via a coupling device, in other embodiments the cutting slate 104 and the cooler 100 are not coupled via a coupling device. In some embodiments, the cutting slate the cutting slate holes 106. Such embodiments do not utilize a coupling device, and instead, the cutting slate 104 simply rests atop the cooler 100. The cutting slates can have features, such as the legs 105, which mimic the dimensions and layout of the cooler 100. This allows the cutting slate 104 to secure and fit snugly atop the cooler 100 without the added coupling device. In these embodiments, to remove the cutting slate 104, the slate 104 is simply lifted away from the cooler 100. Another benefit for this embodiment is that some coolers may not have cooler holes 102. This embodiment allows the user to utilize the system and method of a cutting slate discussed herein even when their cooler lacks the cooler holes 102.

Various dimensions of cutting slates can be utilized. As but one non-limiting example, in one embodiment the cutting slate has a length of 18.730 inches. In other embodiments, the length can vary from about 6 inches to about 36 inches. Those skilled in the art will be able to adjust the cutting slate dimensions as desired. As noted, in one embodiment the cutting slate has the necessary dimensions to sit atop a cooler lid.

FIG. 5 is a perspective view of a slate in one embodiment. As noted, the cooler top can comprise a variety of materials including wood, plastics, metal, polycarbonates, and combinations thereof. As but examples, in one embodiment the slate comprises aluminum. In one embodiment the slate comprises an aluminum powder coat design. In another embodiment the slate comprises laser cut aluminum which is coupled to TUFRAM coating. As noted, in some embodiments the slate can comprise plastics, such as HDPE, and other plastics which are an FDA and USDA approved materials. FIG. 5 shows a top comprising maple wood. FIG. 5 also shows a built in measuring device 112. The measuring device is also shown in FIG. 3. The measuring device allows users to measure the length of the fish, as an example. Other woods can be utilized, including but not limited to, hardwoods, maple, walnut, cedar, etc. As noted, the cooler top, in one embodiment can be mounted with wood screws which utilize the cooler's existing holes. In one embodiment the top is removeable from the cooler so it can be used atop the cooler or as a standalone cooler.

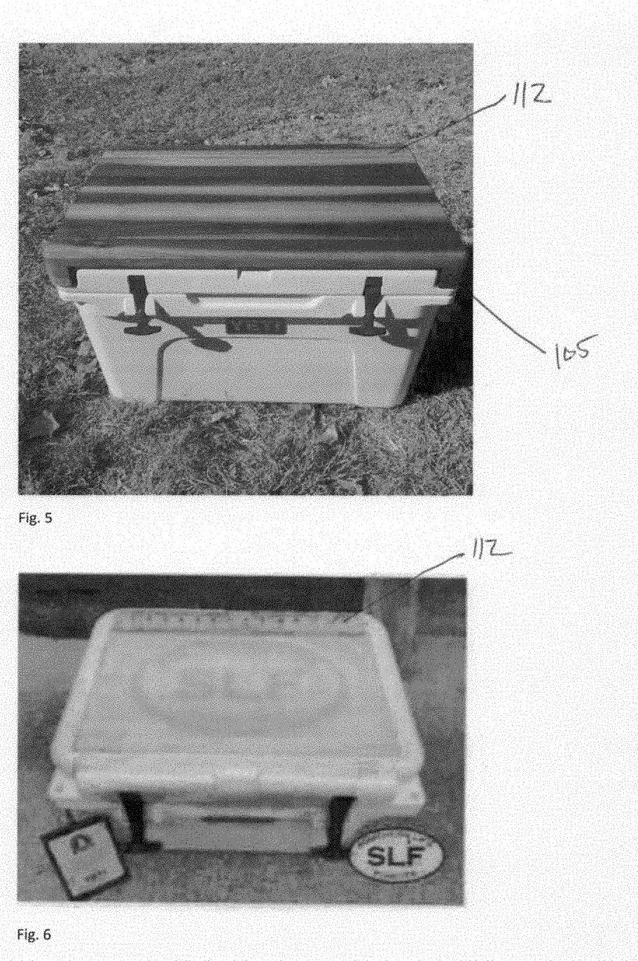

As noted, the top can comprise other materials as well. FIG. 6 is a perspective view of a slate in one embodiment which comprises a polycarbonate top. Polycarbonate offers a lightweight and durable material. As depicted in FIG. 6, the top also comprises a built-in measuring device 112, such as a ruler.

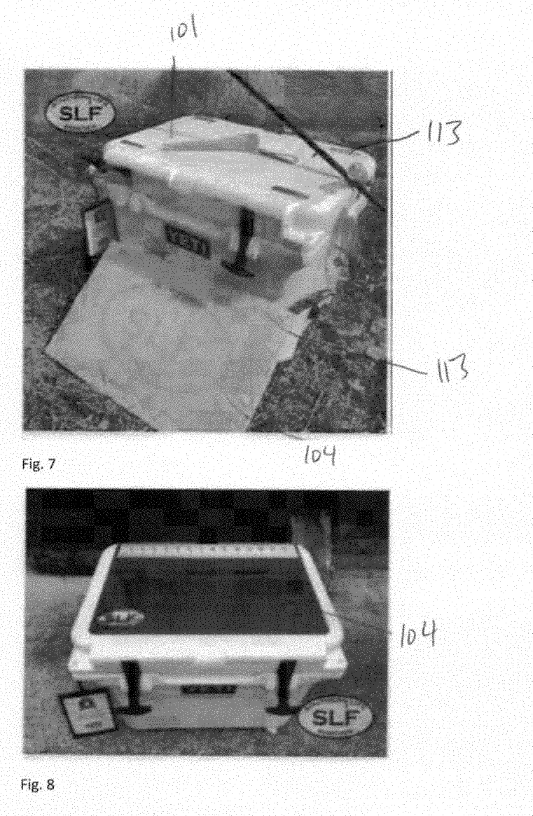

FIG. 7 is a perspective view of a top in one embodiment which comprises magnetic areas 113. As depicted four magnetic areas 113 are located in each corner. The magnetic areas 113 offers a surface which can couple with small metal knives, lures, and other magnetic materials. This ensures knives, lures, etc. will be securely positioned atop the cooler. Various magnetics can be utilized. In one embodiment the magnets comprise neodymium magnets.

In one embodiment the magnetic area 113 are affixed with adhesive to the cooler top 101 and are thus securely attached. The magnetic area 113 can comprise virtually any magnetic material including strong Earth magnets with metal strikers.

In one embodiment the magnetic area 113 are embedded within the cooler top 101. In another embodiment they comprise a protective coating to protect them from the elements. The size, number, and location of the magnetic area 113 can vary. They can be placed in the center or at the edges. Further, in one embodiment the entire top comprises a magnetic area 113. The magnetic area 113 has several benefits including safely storing metal knives, lures, etc. Thus, safety is increased. Further, the magnetic areas 113 prevent items from becoming lost.

As noted, the magnetic areas 113 can be recessed into the cooler top 101, or adhered via adhesive, glue, or the like. As depicted, the slate 104 further comprises either metal or magnetic areas 113 which couple and align with the magnetic areas 113 of the cooler top 101. This allows the slate 104 to secure to the cooler. This allows the slate 104 to couple and decouple as necessary. The cutting slate 104 In one embodiment, the slate 104 remains magnetized in certain portions aligned with the magnetic areas 113. This allows the benefits of the magnetics, described above, to be incorporated even when magnets are not externally visible or obvious.

As noted, in one embodiment the cooler top comprises metal. FIG. 8 is a perspective view of a slate in one embodiment which comprises aluminum. In one embodiment the cooler top 101 comprises magnetic areas 113 which can then couple with the metallic aluminum cutting slate 104. In the areas surrounding the magnetic areas 113, the cutting slate 104 would be magnetized.

While one embodiment has been shown wherein the magnetic areas 113 are on the cooler top 101, in other embodiments the magnetic areas 113 are located on the cutting slate 104. The same benefits discussed above herein, result from the magnetic areas 113 on the cutting slate 104. In one such embodiment the cooler top 101 will comprise metal, or additional magnets, which couple with the magnetic areas 113 located on the cutting slate 104.

As noted, the cutting slate 104 can be coupled via hinges, magnets, adhesive, and virtually any other method or device known in the art. This allows the benefit of adding and removing the cutting slate quickly and easily.

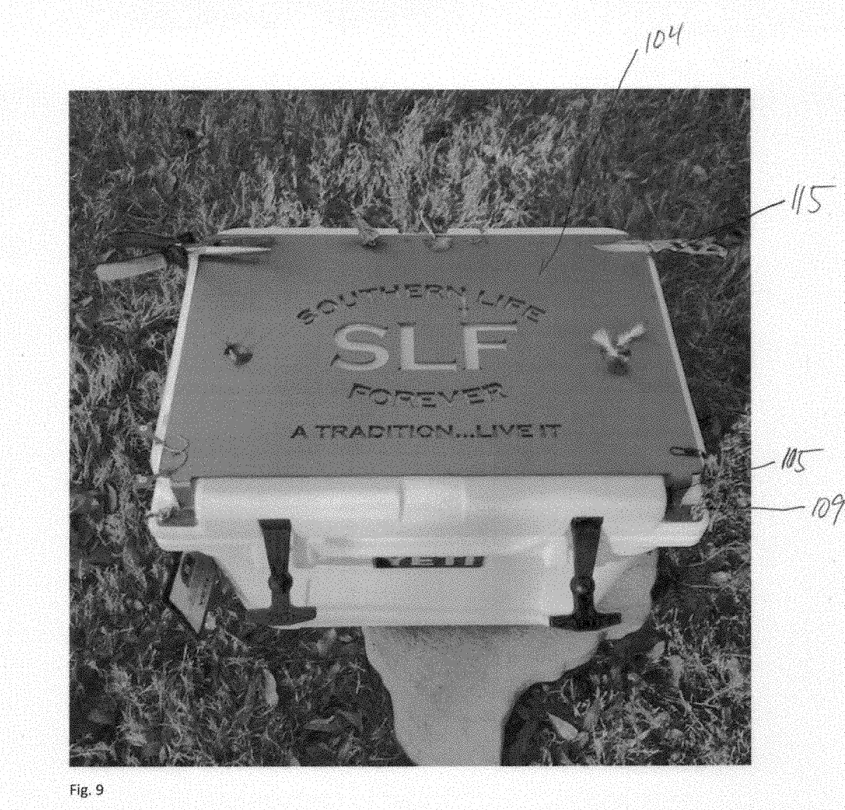

FIG. 9 is a perspective view of a slate in one embodiment. As depicted the slate 104 is metallic. The legs 105 extend downward beyond the generally planar top. As shown, the legs extend downward and then outward, having an L-shape. In this embodiment the legs have cutting slate holes 106 which extend to the upper surface of the legs 105. In this way, the slate 104 can be coupled to the cooler via screws 109. The screws 109, or other coupling device such as bolts, wing nuts, etc., in this embodiment, are visible.

FIG. 9 shows that various tools 115 such as knives, lures, hooks, etc. can be kept attached to the slate 104 via the magnetic areas 113.

As noted, the slate 104 provides an opportunity to cut, slice, and prepare items such as game and food without damaging the cooler. Because the slate 104 can be coupled to the cooler, the slate 104 remains with and atop the cooler until the user decides to physically decouple the slate 104. This is a benefit before the slate 104 is securely coupled to the cooler. This provides increased safety and stability when, for example, the slate 104 is used for cutting. An unstable cutting platform is inherently unsafe. Accordingly, increasing the stability of the slate increases the safety of the cooler and slate combination. Further, as previously noted, anglers, hunters, picnic goers, etc., already have plenty of gear and equipment to carry. By coupling the slate to the cooler allows the user to carry the cooler, and have the added advantages of the slate without having to separately carry the slate.

While the invention has been particularly shown and described with reference to a preferred embodiment, it will be understood by those skilled in the art that various changes in form and detail may be made therein without departing from the spirit and scope of the invention.

### Additional Description

The following clauses are offered as further description of the disclosed invention.
Clause 1. A system for coupling a cutting slate to a cooler, said system comprising:

a cooler with a top;

a cutting slate sized to sit atop said cooler top;

wherein said cutting slate comprises a cutting slate top.
Clause 2. The system of any proceeding or preceding clause wherein said cooler top comprises a generally planar top, and wherein said cooler top comprises two tapered corners, wherein said two tapered corners are located at a lower elevation than said generally planar top.
Clause 3. The system of any proceeding or preceding clause wherein said cutting slate comprises legs which correspond to said tapered corners, and wherein said legs extend out beyond a generally planar top.
Clause 4. The system of any proceeding or preceding clause wherein said top of said cooler comprises cooler holes, and wherein said cutting slate comprises cutting slate holes, and wherein said cutting slate is coupled to said cooler via said cutting slate holes and said cooler holes.
Clause 5. The system of any proceeding or preceding clause wherein said cutting slate is coupled to said cooler via screws which extend into said cutting slate holes and said cooler holes.
Clause 6. The system of any proceeding or preceding clause wherein said cutting slate comprises a lip which raises out of a plane on a bottom side of said cutting slate, and wherein said lip aligns with a back end of said cooler.
Clause 7. The system of any proceeding or preceding clause wherein said cutting slate top comprises a food grade material.
Clause 8. The system of any proceeding or preceding clause wherein said top of said cooler comprises a hinge to open and close relative to said cooler, and wherein said cutting slate does not have to be decoupled from said cooler top to open and close said cooler top.
Clause 9. The system of any proceeding or preceding clause wherein said cutting slate top is generally planar.
Clause 10. The system of any proceeding or preceding clause wherein said cutting slate does not have holes, and wherein no coupling device is used to couple said cutting slate to said cooler top.
Clause 11. The system of any proceeding or preceding clause wherein said cutting slate top comprises a measuring device.
Clause 12. The system of any proceeding or preceding clause wherein said cutting slate comprises wood.
Clause 13. The system of any proceeding or preceding clause wherein said cooler top comprises at least one magnetic area.
Clause 14. The system of any proceeding or preceding clause wherein said at least one magnetic area is embedded within said cooler top.
Clause 15. The system of any proceeding or preceding clause wherein said cutting slate is metallic.
Clause 16. The system of any proceeding or preceding clause wherein said cutting slate comprises at least one magnetic area.
Clause 17. The system of any proceeding or preceding clause wherein said cooler top comprises plastic.

What is claimed is:

1. A system for coupling a cutting slate to a cooler, said system comprising:
a cooler with a top;
a cutting slate sized to sit atop said cooler top;
wherein said cutting slate comprises a cutting slate top.

2. The system of claim 1 wherein said cooler top comprises a generally planar top, and wherein said cooler top comprises two tapered corners, wherein said two tapered corners are located at a lower elevation than said generally planar top.

3. The system of claim 2 wherein said cutting slate comprises legs which correspond to said tapered corners, and wherein said legs extend out beyond a generally planar top.

4. The system of claim 1 wherein said top of said cooler comprises cooler holes, and wherein said cutting slate comprises cutting slate holes, and wherein said cutting slate is coupled to said cooler via said cutting slate holes and said cooler holes.

5. The system of claim 4 wherein said cutting slate is coupled to said cooler via screws which extend into said cutting slate holes and said cooler holes.

6. The system of claim 1 wherein said cutting slate comprises a lip which raises out of a plane on a bottom side of said cutting slate, and wherein said lip aligns with a back end of said cooler.

7. The system of claim 1 wherein said cutting slate top comprises a food grade material.

8. The system of claim 1 wherein said top of said cooler comprises a hinge to open and close relative to said cooler, and wherein said cutting slate does not have to be decoupled from said cooler top to open and close said cooler top.

9. The system of claim 1 wherein said cutting slate top is generally planar.

10. The system of claim 1 wherein said cutting slate does not have holes, and wherein no coupling device is used to couple said cutting slate to said cooler top.

11. The system of claim 1 wherein said cutting slate top comprises a measuring device.

12. The system of claim 1 wherein said cutting slate comprises wood.

13. The system of claim 1 wherein said cooler top comprises at least one magnetic area.

14. The system of claim 13 wherein said at least one magnetic area is embedded within said cooler top.

15. The system of claim 13 wherein said cutting slate is metallic.

16. The system of claim 1 wherein said cutting slate comprises at least one magnetic area.

17. The system of claim 1 wherein said cooler top comprises plastic.
